(19) United States
(12) Patent Application Publication
(10) Pub. No.: US 2020/0310677 A1
(43) Pub. Date: Oct. 1, 2020

(54) APPARATUS AND METHOD FOR CONTROLLING WRITE OPERATION OF MEMORY SYSTEM

(71) Applicant: SK hynix Inc., Gyeonggi-do (KR)

(72) Inventor: Eu-Joon BYUN, Gyeonggi-do (KR)

(21) Appl. No.: 16/669,075

(22) Filed: Oct. 30, 2019

(30) Foreign Application Priority Data
Mar. 27, 2019 (KR) 10-2019-0035005

(51) Int. Cl. G06F 3/06; G06F 11/07

(52) U.S. Cl. CPC G06F 3/0656; G06F 3/0659; G06F 3/0679; G06F 11/0751; G06F 3/0653; G06F 3/0631; G06F 3/0619

(57) ABSTRACT

A memory system includes a memory device including a nonvolatile memory region and a data buffer configured to temporarily store a piece of data stored in the nonvolatile memory region, and a controller configured to store write data, which is delivered with a program command inputted from a host including a second memory, in a first memory, and to send the write data to both the data buffer and the host when a program operation corresponding to the program command is performed.

### CROSS-REFERENCE TO RELATED APPLICATION

This patent application claims priority under 35 U.S.C. § 119(a) to Korean Patent Application No. 10-2019-0035005, filed on Mar. 27, 2019, the entire disclosure of which is incorporated herein by reference.

### TECHNICAL FIELD

Various embodiments generally relate to a memory system and a data processing system including the memory system, and more particularly, to an apparatus and a method for using a memory in a host or a computing device for programming data within a memory system in a data processing system.

### BACKGROUND

Recently, a paradigm for a computing environment has shifted to ubiquitous computing, which enables computer systems to be accessed anytime and everywhere. As a result, the use of portable electronic devices, such as mobile phones, digital cameras, notebook computers and the like, are rapidly increasing. Such portable electronic devices typically use or include a memory system that uses or embeds at least one memory device, i.e., a data storage device. The data storage device can be used as a main storage device or an auxiliary storage device of a portable electronic device.

Unlike a hard disk, a data storage device using a nonvolatile semiconductor memory device is advantageous in that it has excellent stability and durability because it has no mechanical driving part (e.g., a mechanical arm), and has high data access speed and low power consumption. In the context of a memory system having such advantages, an exemplary data storage device includes a universal serial bus (USB) memory device, a memory card having various interfaces, a solid state drive (SSD) or the like.

### BRIEF DESCRIPTION OF THE DRAWINGS

The description herein makes reference to the accompanying drawings wherein like reference numerals refer to like parts throughout the figures, and wherein:

FIG. 1 illustrates a method of operating a memory system according to an embodiment of the disclosure;

FIG. 2 illustrates an example of a data processing system including a memory system according to an embodiment of the disclosure;

FIG. 3 illustrates a controller in a memory system according to an embodiment of the disclosure;

FIGS. 4 to 6 illustrate an example of utilizing a partial area in a memory in a host as a device which is capable of temporarily storing user data as well as metadata;

FIG. 7 illustrates a first operation of a host and a memory system according to an embodiment of the disclosure;

FIG. 8 illustrates an operation of a controller according to an embodiment of the disclosure;

FIG. 9 illustrates a second operation of a host and a memory system according to an embodiment of the disclosure;

FIG. 10 illustrates a re-program operation according to an embodiment of the disclosure;

FIG. 11 illustrates a third operation of a memory system according to an embodiment of the disclosure;

FIG. 12 illustrates a fourth operation of a memory system according to an embodiment of the disclosure; and

FIG. 13 illustrates a fifth operation of a memory system according to an embodiment of the disclosure.

### DETAILED DESCRIPTION

Various embodiments of the disclosure are described below in with reference to the accompanying drawings. Elements and features of the disclosure, however, may be configured or arranged differently to form other embodiments, which may be variations of any of the disclosed embodiments. Thus, the present teachings are not limited to the embodiments set forth herein. Rather, the described embodiments are provided so that this disclosure is thorough and complete and fully conveys the scope of the disclosure to those skilled in the art to which the present teachings pertain. It is noted that reference to “an embodiment,” “another embodiment” or the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance could also be termed a second or third element in another instance without departing from the spirit and scope of the present teachings.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via an intervening element therebetween. In addition, it will also be understood that when an element is referred to as being “between” two elements, it may be the only element between the two elements, or one or more intervening elements may also be present.

The terminology used herein is for the purpose of describing particular embodiments only and is not intended to be limiting. As used herein, singular forms are intended to include the plural forms and vice versa, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art. It will be further understood that terms, such as those defined in commonly used dictionaries, should be interpreted as having a meaning that is consistent with their meaning in the context of the disclosure and the relevant art, and not be interpreted in an idealized or overly formal sense unless expressly so defined herein.

In the following description, numerous specific details are set forth in order to provide a thorough understanding of the disclosure. The teachings disclosed herein may be practiced without some or all of these specific details. In other instances, well-known process structures and/or processes have not been described in detail in order not to unnecessarily obscure the teachings disclosed herein.

It is also noted, that in some instances, as would be apparent to those skilled in the relevant art, a feature or element described in connection with one embodiment may be used singly or in combination with other features or elements of another embodiment, unless otherwise specifically indicated.

Embodiments of the disclosure may provide a memory system, a data processing system or a method for operating the memory system or the data processing system, which is capable of transferring data between components of the memory system quickly so as to program the data onto a nonvolatile memory device quickly.

In an embodiment, a data processing system may include a memory system and a host (or a computing device). At least some portion of a memory in the host or the computing device is allocated for a backup of write data in order to reduce an operational burden of storing the write data in a data buffer of the memory system until the memory system properly completes a program operation regarding the write data in a nonvolatile memory block. By utilizing the memory in the host or the computing device as a backup device for write data, it is possible to improve or enhance the speed of a write operation in the memory system.

In embodiments of the disclosure, in a process of programming write data onto a nonvolatile memory block in a data processing system including a host or a computing device, even if a piece of the write data is not properly written to the nonvolatile memory block, that piece of the write data may be selectively re-programmed after plural unit program operations, each corresponding to each piece of the write data, are attempted.

In an embodiment, a memory system can include a memory device including a nonvolatile memory region and a data buffer configured to temporarily store a piece of data stored in the nonvolatile memory region; and a controller configured to store write data, which is delivered with a program command from a host including a second memory, in a first memory, and to send the write data to both the data buffer and the host when a program operation corresponding to the program command is performed.

By way of example but not limitation, the data buffer can be configured to release the write data before it is verified whether or not the write data has been successfully programmed to the nonvolatile memory region.

The first memory can be configured to release the write data after sending the write data to the data buffer.

The controller can be configured to obtain the write data from the second memory, when programming the write data to the nonvolatile memory region failed.

The controller can be configured to divide the write data into plural pieces of write data, each piece having a set size, assign an identifier to each of the plural pieces of write data, and send the plural pieces of write data and their respective identifiers to both the data buffer and the second memory.

The memory device can be configured to send a signal indicating a program success/failure to the controller in response to the identifier assigned to each of the plural pieces of write data.

The controller can be configured to determine that only a piece of write data matched with its identifier corresponding to the program failure is reprogrammed.

The controller can be configured to determine that plural pieces of write data matched with a first identifier to a last identifier, at least one of which corresponds to the program failure, are reprogrammed.

The controller can be configured to access the second memory to obtain a piece of write data to be programmed again.

The controller can be configured to request the host to allocate a storage area of the first memory for an operation of the memory system, wherein the storage area is configured to store a maximum number of the plural pieces of write data matched with their identifiers.

In another embodiment, a method for operating memory system can include receiving a piece of write data with a write command from a host and storing the piece of write data in a cache; sending the piece of write data to a data buffer and a host memory when a write operation corresponding to the write command is performed or begun; and programming the piece of write data sent to the data buffer to a nonvolatile memory region.

The write data in the data buffer can be released before it is verified whether or not the write data has been successfully programmed to the nonvolatile memory region.

The write data in the cache can be released after sending the write data to the data buffer.

The method can further include obtaining the write data from the host memory, when programming the write data to the nonvolatile memory region failed.

The write data can be divided into plural pieces of write data, each piece having a set size. An identifier can be assigned to each of the plural pieces of write data. The plural pieces of write data and their respective identifiers can be transferred to both the data buffer and the host memory.

The method can further include determining a program success/failure in response to the identifier assigned to each of the plural pieces of write data.

The method can further include determining that only a piece of write data matched with its identifier corresponding to the program failure is reprogrammed.

The method can further include determining that plural pieces of write data matched with a first identifier to a last identifier, at least one of which corresponds to the program failure, are reprogrammed.

The method can further include accessing the host memory to obtain a piece of write data to be programmed again.

The method can further include requesting the host to allocate a storage area of the first memory for an operation of the memory system. Herein, the storage area is capable of storing a maximum number of the plural pieces of write data matched with their respective identifiers.

In another embodiment, a data processing system can include a host configured to generate a write command and write data; and a memory system including a nonvolatile memory device, a data buffer capable of storing the write data, and a controller configured to store the write data, which is delivered with a program command from the host including a host memory, in a cache, and send the write data to both the data buffer and the host when a program operation corresponding to the program command is performed.

The controller can request the host to send the write data when the program operation of the write data to the nonvolatile memory device failed. The host can transmit the write data in response to a request of the controller.

The controller can request the host to allocate a storage area in the host memory for an operation of the memory system. The storage area is accessible by the controller. The host can allow that the controller accesses the storage area in the host memory.

In another embodiment, a data processing system can include a host including a host memory, a memory device including a memory region and a data buffer for storing one or more pieces of data to be stored in the memory region; and a controller including a memory and configured to sequentially receive the one or more pieces of data from the host; assign an identifier to each piece of data; store the one or more pieces of data in the memory device; transmit the one or more pieces of data and corresponding identifiers to both the data buffer and the host memory.

Embodiments of the disclosure are described in more detail below with reference to the accompanying drawings, wherein like numbers reference like elements.

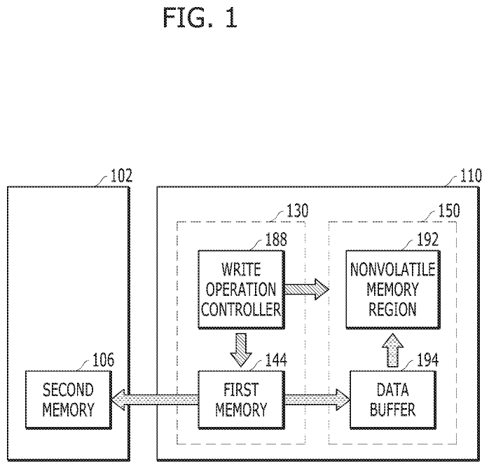

FIG. 1 illustrates a data processing system in accordance with an embodiment of the disclosure. Referring to FIG. 1, the data processing system includes a host 102 and a memory system 110 which is operatively engaged with the host 102. The memory system 110 may perform a write operation in response to a write command so that a piece of write data received from the host 102 can be programmed to a memory device 150. In FIG. 1, as shown by the arrows, there are two different operational flows: one shows that a write operation controller 188 controls other components in the memory system 110; and the other shows that transmission of the write data between other components or between the host 102 and the memory system 110.

The memory system 110 may be divided into a controller 130 and the memory device 150. The controller 130 may be coupled with the memory device 150 via at least one channel. The memory device 150 may include a nonvolatile memory region 192 including a plurality of nonvolatile memory cells. The nonvolatile memory region 192 may include at least one structure of die, plane, block, or page. The times it takes to store (or program) a piece of data in, or read a piece of data from, nonvolatile memory cells (e.g., tPROG, tR respectively) may be longer than a time it takes for a piece of data to be transmitted between the controller 130 and the memory device 150 within the memory system 110 or between the host 102 and the memory system 110. In order to improve data input and output (I/O) performance (e.g., I/O throughput) of the memory system 110, the memory device 150 may include a data buffer 194.

The data buffer 194 may temporarily store a piece of data during a read operation or a write (or program) operation, i.e., processes of delivering the piece of data into the nonvolatile memory region 192 or outputting the piece of data stored in the nonvolatile memory region 192. The data buffer 194 may include plural volatile memory cells. For example, performance of the memory system 110 might be not great when the controller 130 does not process any operation while a piece of data is programmed in the nonvolatile memory region 192, e.g., the controller 130 is in standby until the piece of data is completely programmed. Accordingly, the controller 130 may transfer the piece of data for programming to the data buffer 194 and then perform another operation.

While or after a piece of data is programmed into the nonvolatile memory region 192, it may be verified whether the piece of data is properly programmed. When it is recognized that the piece of data is not completely programmed based on a verification result, the piece of data should be re-programmed in the nonvolatile memory region 192.

In general, the total time spent on both an operation for programming a piece of data in the nonvolatile memory region 192 and an operation for verifying whether the piece of data is programmed may be long. The piece of data should be temporarily stored in the data buffer 194 during both a program operation and a verification operation. After the verification operation, the piece of data temporarily stored in the data buffer 194 may be released. When the piece of data is not completely or properly programmed in the nonvolatile memory region 192, the piece of data temporarily stored in the data buffer 194 may be used for re-programming the piece of data in the nonvolatile memory region 192.

The above described operation is possible only when the data buffer 194 holds the piece of data for a long time during the program operation and the verification operation. When an amount of write data programmed in the nonvolatile memory region 192 is not large, performance of the memory system 110 might not be significantly affected even if the data buffer 194 holds the piece of data for a long time. However, when a large amount of write data (e.g., voluminous data) is input or plural pieces of write data are continuously or sequentially inputted along with at least one write command from the host 102, the memory system 110 may be affected. In any of these cased, the combination of the program operation and verification operation may cause an operational delay. When the data buffer 194 holds some pieces of the write data for a long time and has no room for another piece of the write data, the controller 130 cannot send another piece of write data to the data buffer 194. In order to avoid such a bottleneck, a method of increasing a storage capability of the data buffer 194 in the memory device 150 may be considered. However, this may increase manufacturing cost or the size of the memory system 110, neither of which is desirable.

The controller 130 may control a write operation corresponding to a write command and a piece of write data inputted from the host 102. The write operation controller 188 in the controller 130 may transmit a piece of write data stored in the first memory 144 to the data buffer 194 in the memory device 150 and the host 102, when the write operation is performed corresponding to a write command. During the write operation, the write operation controller 188 may transmit a piece of write data to both the data buffer 194 and the host 102 bidirectionally so that a bottleneck occurring in the data buffer 194 may be avoided.

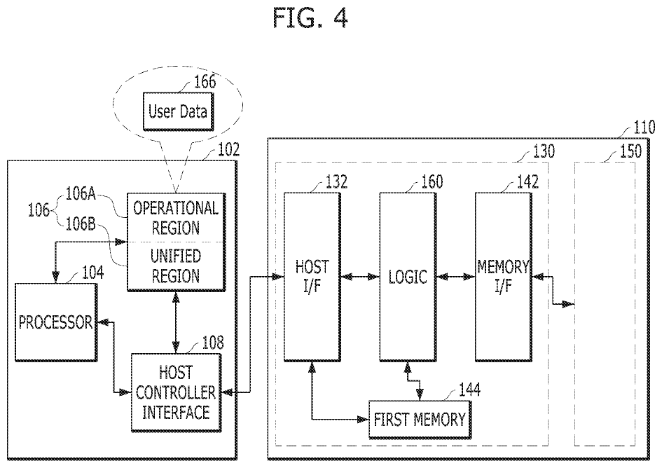

Specifically, when a piece of write data stored in the first memory 144 is transferred to the data buffer 194, the same piece of write data may be also transferred to the host 102. The host 102 may store the piece of write data received from the memory system 110 in a second memory 106, e.g., a previously allocated storage area, for an operation of the memory system 110. The second memory 106 is described in more detail with reference to FIG. 4 below.

When a piece of write data stored in the first memory 144 is transferred to the data buffer 194, the data buffer 194 temporarily stores the transferred piece of write data. Herein, after the programming of the piece of write data in the nonvolatile memory region 192 has begun, the data buffer 194 may not hold the piece of write data until a verification result for programming the piece of write data is received from the nonvolatile memory region 192. Rather, the data buffer 194 may release the piece of write data before receiving such verification result after transferring the piece of write data to the nonvolatile memory region 192. After releasing the piece of write data, the data buffer 194 may receive and temporarily store another piece of write data. The data buffer 194 may hold the data for a short time, thereby avoiding a bottleneck that may occur in the data buffer 194.

On the other hand, because the data buffer 194 does not hold a piece of write data until a program verification regarding the piece of write data is received, such write data is not available in the data buffer 194 when that data is not programmed in the nonvolatile memory region 192 completely (i.e., a program failure occurs). In this case, the controller 130 may request the host 102 to transmit a corresponding piece of write data. The host 102 may transmit the corresponding piece of write data in response to a request (or an inquiry) of the controller 130. The write operation controller 188 may transfer the transmitted piece of write data to the data buffer 194. Then, the piece of write data may be re-programmed in the nonvolatile memory region 192.

When an operational state of the nonvolatile memory region 192 in the memory device 150 is good (e.g., the nonvolatile memory region 192 works well), it may be rare that a piece of write data is not completely programmed. Thus, when a bottleneck in the data buffer 194 may be avoided, a time spent on programming a large amount of write data or plural pieces of write data into the nonvolatile memory region 192 may be shortened. Since it is not common that a piece of write data is not completely programmed, an operation of utilizing a piece of write data re-transmitted from the host 102 in response to a program failure for re-programming the piece of write data in the non-volatile memory region 192 may be not considered a big overhead or a great burden in a view of data input/output (I/O) performance of the memory system 110.

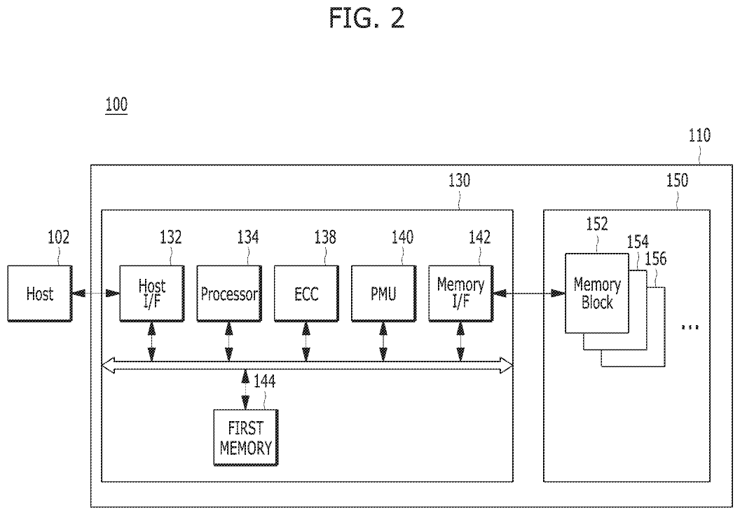

Various embodiments of the disclosure are described in more detail with reference to FIGS. 2 to 13.

FIG. 2 illustrates a data processing system 100. Referring to FIG. 2, the data processing system 100 may include a host 102 and a memory system 110 which are operatively engaged with each other.

The host 102 may include, for example, a portable electronic device such as a mobile phone, an MP3 player and a laptop computer, or an electronic device such as a desktop computer, a game player, a television (TV), a projector and the like.

The host 102 also includes at least one operating system (OS), which can generally manage, and control, functions and operations performed in the host 102. The OS may provide interoperability between the host 102 engaged with the memory system 110 and the user needing and using the memory system 110. The OS may support functions and operations corresponding to user's requests. By way of example but not limitation, the OS may be classified into a general operating system and a mobile operating system according to mobility of the host 102. The general operating system may be split into a personal operating system and an enterprise operating system according to system requirements or a user's environment. The personal operating system, including Windows and Chrome, may be subject to support services for general purposes. But the enterprise operating systems can be specialized for securing and supporting high performance, including Windows servers, Linux, Unix and the like. Further, the mobile operating system may include an Android, an iOS, a Windows mobile and the like. The mobile operating system may be subject to support services or functions for mobility (e.g., a power saving function). The host 102 may include a plurality of operating systems. The host 102 may execute multiple operating systems interlocked with the memory system 110, corresponding to a user's request. The host 102 may transmit a plurality of commands corresponding to the user's requests into the memory system 110, thereby performing operations corresponding to commands within the memory system 110. Handling a command in the memory system 110 is described below, particularly in reference to FIG. 4.

The memory system 110 may operate or perform a specific function or operation in response to a request from the host 102 and, particularly, may store data to be accessed by the host 102. The memory system 110 may be used as a main memory system or an auxiliary memory system of the host 102. The memory system 110 may be implemented with any of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device, for example, a dynamic random access memory (DRAM) and a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM) and a flash memory.

The memory system 110 may include a controller 130 and a memory device 150. The memory device 150 may store data to be accessed by the host 102. The controller 130 may control storage of data in the memory device 150.

The controller 130 and the memory device 150 may be integrated into a single semiconductor device, which may be any of the various types of memory systems exemplified above.

By way of example but not limitation, the controller 130 and the memory device 150 may be integrated into a single semiconductor device. The controller 130 and memory device 150 may be integrated into an SSD for improving an operation speed. When the memory system 110 is used as an SSD, the operating speed of the host 102 connected to the memory system 110 may be improved more than that of the host 102 implemented with a hard disk. In addition, the controller 130 and the memory device 150 may be integrated into one semiconductor device to form a memory card, such as a PC card (PCMCIA), a compact flash card (CF), a memory card such as a smart media card (e.g., SM, SMC), a memory stick, a multimedia card (e.g., MMC, RS-MMC, MMCmicro), a secure digital (SD) card (e.g., SD, miniSD, microSD, SDHC), a universal flash memory or the like.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device and may retain data stored therein even while an electrical power is not supplied. The memory device 150 may store data provided from the host 102 through a write operation, while providing data stored therein to the host 102 through a read operation. The memory device 150 may include a plurality of memory blocks 152, 154, 156, each of which may include a plurality of pages. Each of the plurality of pages may include a plurality of memory cells to which a plurality of word lines (WL) are electrically coupled. The memory device 150 also includes a plurality of memory dies, each of which includes a plurality of planes, each of which includes a plurality of memory blocks 152, 154, 156. In addition, the memory device 150 may be a non-volatile memory device, for example a flash memory, wherein the flash memory may be a three-dimensional stack structure.

The controller 130 may control overall operations of the memory device 150, such as read, write, program and erase operations. For example, the controller 130 may control the memory device 150 in response to a request from the host 102. The controller 130 may provide the data, read from the memory device 150, with the host 102. The controller 130 may store the data, provided by the host 102, into the memory device 150.

The controller 130 may include a host interface (I/F) 132, a processor 134, an error correction code (ECC) component 138, a power management unit (PMU) 140, a memory interface (I/F) 142 and a memory 144, all operatively coupled via an internal bus.

The host interface 132 may process commands and data provided from the host 102, and may communicate with the host 102 through at least one of various interface protocols such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), small computer system interface (SCSI), enhanced small disk interface (ESDI) and integrated drive electronics (IDE). In accordance with an embodiment, the host interface 132 is a component for exchanging data with the host 102, which may be implemented through firmware called a host interface layer (HIL).

The ECC component 138 may correct error bits of the data to be processed in (e.g., outputted from) the memory device 150, which may include an ECC encoder and an ECC decoder. Here, the ECC encoder may perform error correction encoding of data to be programmed in the memory device 150 to generate encoded data into which a parity bit is added and store the encoded data in memory device 150. The ECC decoder may detect and correct errors contained in a data read from the memory device 150 when the controller 130 reads the data stored in the memory device 150. In other words, after performing error correction decoding on the data read from the memory device 150, the ECC component 138 may determine whether the error correction decoding has succeeded and output an instruction signal (e.g., a correction success signal or a correction fail signal). The ECC component 138 may use the parity bit which is generated during the ECC encoding process, for correcting the error bit of the read data. When the number of the error bits is greater than or equal to a threshold number of correctable error bits, the ECC component 138 might not correct error bits but instead may output an error correction fail signal indicating failure in correcting the error bits.

The ECC component 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC component 138 may include any and all circuits, modules, systems or devices for performing the error correction operation based on at least one of the above described codes.

The PMU 140 may manage an electrical power provided in the controller 130.

The memory interface 142 may serve as an interface for handling commands and data transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134 in a case when the memory device 150 is a flash memory and, in particular, when the memory device 150 is a NAND flash memory. The memory interface 142 may provide an interface for handling commands and data between the controller 130 and the memory device 150, for example, operations of NAND flash interface, in particular, operations between the controller 130 and the memory device 150. In accordance with an embodiment, the memory interface 142 may be implemented through firmware called a Flash Interface Layer (FIL) as a component for exchanging data with the memory device 150.

The first memory 144 may support operations performed by the memory system 110 and the controller 130. The first memory 144 may store temporary or transactional data occurred or delivered for operations in the memory system 110 and the controller 130. The controller 130 may control the memory device 150 in response to a request from the host 102. The controller 130 may deliver data read from the memory device 150 into the host 102. The controller 130 may store data entered through the host 102 within the memory device 150. The first memory 144 may be used to store data for the controller 130 and the memory device 150 to perform operations such as read operations or program/write operations.

The first memory 144 may be implemented with a volatile memory. The first memory 144 may be implemented with a static random access memory (SRAM), a dynamic random access memory (DRAM) or both. Although FIG. 2 illustrates, for example, the first memory 144 disposed within the controller 130, the embodiments are not limited thereto. That is, the first memory 144 may be located within or external to the controller 130. For instance, the first memory 144 may be embodied by an external volatile memory having a memory interface transferring data and/or signals between the first memory 144 and the controller 130.

The first memory 144 may store data necessary for performing operations such as data writing and data reading requested by the host 102 and/or data transfer between the memory device 150 and the controller 130 for background operations such as garbage collection and wear levelling as described above. In accordance with an embodiment, for supporting operations in the memory system 110, the first memory 144 may include a program memory, a data memory, a write buffer/cache, a read buffer/cache, a data buffer/cache, a map buffer/cache, and the like.

The processor 134 may be implemented with a microprocessor or a central processing unit (CPU). The memory system 110 may include one or more processors 134. The processor 134 may control the overall operations of the memory system 110. By way of example but not limitation, the processor 134 may control a program operation or a read operation of the memory device 150, in response to a write request or a read request entered from the host 102. In accordance with an embodiment, the processor 134 may use or execute firmware to control the overall operations of the memory system 110. Herein, the firmware may be referred to as a flash translation layer (FTL). The FTL may perform an operation as an interface between the host 102 and the memory device 150. The host 102 may transmit requests for write and read operations to the memory device 150 through the FTL.

The FTL may manage operations of address mapping, garbage collection, wear-leveling and the like. Particularly, the FTL may load, generate, update, or store map data. Therefore, the controller 130 may map a logical address, which is entered from the host 102, with a physical address of the memory device 150 through the map data. The memory device 150 may operate like a general storage device to perform a read or write operation because of the address mapping operation. Also, through the address mapping operation based on the map data, when the controller 130 tries to update data stored in a particular page, the controller 130 may program the updated data on another empty page and may invalidate old data of the particular page (e.g., update a physical address, corresponding to a logical address of the updated data, from the previous particular page to the another newly programed page) due to a characteristic of a flash memory device. Further, the controller 130 may store map data of the new data into the FTL.

When performing an operation requested from the host 102 in the memory device 150, the controller 130 uses the processor 134. The processor 134 may handle instructions or commands corresponding to a command received from the host 102. The controller 130 may perform a foreground operation as a command operation, corresponding to an command inputted from the host 102, such as a program operation corresponding to a write command, a read operation corresponding to a read command, an erase/discard operation corresponding to an erase/discard command and a parameter set operation corresponding to a set parameter command or a set feature command with a set command.

For another example, the controller 130 may perform a background operation on the memory device 150 through the processor 134. By way of example but not limitation, the background operation includes copying data stored in a memory block among the memory blocks 152, 154, 156 and storing the copied data in another memory block, e.g., a garbage collection (GC) operation. The background operation may include an operation of moving or swapping data stored in at least one of the memory blocks 152, 154, 156 into at least another of the memory blocks 152, 154, 156, e.g., a wear leveling (WL) operation. During a background operation, the controller 130 may use the processor 134 for storing the map data stored in the controller 130 in at least one of the memory blocks 152, 154, 156 in the memory device 150, e.g., a map flush operation. A bad block management operation of checking or searching for bad blocks among the memory blocks 152, 154, 156 is another example of a background operation performed by the processor 134.

In the memory system 110, the controller 130 performs a plurality of command operations corresponding to a plurality of commands entered from the host 102. For example, when performing a plurality of program operations corresponding to plural program commands, a plurality of read operations corresponding to plural read commands and a plurality of erase operations corresponding to plural erase commands sequentially, randomly or alternatively, the controller 130 may determine which channel(s) or way(s) among a plurality of channels (or ways) for connecting the controller 130 to a plurality of memory dies in the memory 150 is/are proper or appropriate for performing each operation. The controller 130 may transmit data or instructions via determined channels or ways for performing each operation. The plurality of memory dies may transmit an operation result via the same channels or ways, respectively, after each operation is complete. Then, the controller 130 may transmit a response or an acknowledge signal to the host 102. In an embodiment, the controller 130 may check a status of each channel or each way. In response to a command entered from the host 102, the controller 130 may select at least one channel or way based on the status of each channel or each way so that instructions and/or operation results with data may be delivered via selected channel(s) or way(s).

By way of example but not limitation, the controller 130 may recognize statuses regarding a plurality of channels (or ways) associated with a plurality of memory dies in the memory device 150. The controller 130 may determine the state of each channel or each way as one of a busy state, a ready state, an active state, an idle state, a normal state and/or an abnormal state. The controller 130 may determine which channel or way an instruction (and/or a data) is delivered through, based on a physical block address, e.g., to which die(s) the instruction (and/or the data) is delivered. The controller 130 may refer to descriptors delivered from the memory device 150. The descriptors may include a sort of data having a set format or structure, which is stored in a block or a page storing parameters (or data) that describe relevant information or relevant processing considerations regarding the memory device 150. For instance, the descriptors may include device descriptors, configuration descriptors, unit descriptors, and the like. The controller 130 may refer to, or use, the descriptors to determine with which channel(s) or way(s) an instruction or a data is exchanged.

A management unit (not shown) may be included in the processor 134. The management unit may perform bad block management of the memory device 150. The management unit may find bad memory blocks in the memory device 150, which are in unsatisfactory condition for further use, as well as perform bad block management on the bad memory blocks. When the memory device 150 is a flash memory, for example, a NAND flash memory, a program failure may occur during the write operation (or the program operation), due to characteristics of a NAND logic function. During the bad block management, the data of the program-failed memory block or the bad memory block may be programmed into a new memory block. The bad blocks may seriously aggravate the utilization efficiency of the memory device 150 having a three-dimensional (3D) stack structure and the reliability of the memory system 110. Thus, reliable bad block management may enhance or improve performance of the memory system 110.

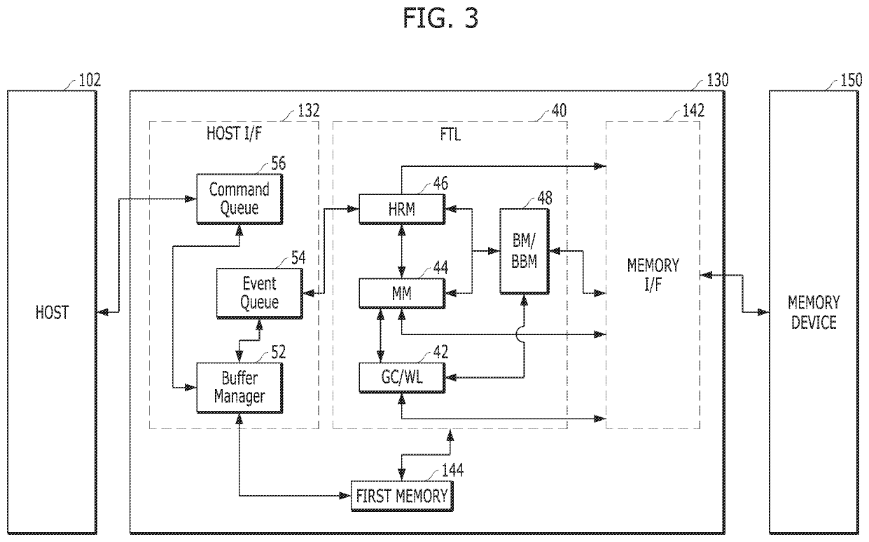

FIG. 3 illustrates a controller 130 of a memory system in accordance with an embodiment of the disclosure. Referring to FIG. 3, the controller 130 cooperates with the host 102 and the memory device 150. The controller 130 includes a host interface (I/F) 132, a memory interface (I/F) 142, a memory 144 and a flash translation layer (FTL) 40.

Although not shown in FIG. 3, the ECC component 138 of FIG. 2 may be included in the flash translation layer (FTL) 40. In another embodiment, the ECC component 138 may be implemented as a separate module, a circuit, firmware or the like, which is included in, or associated with, the controller 130.

The host interface 132 may handle commands, data, and the like received from the host 102. By way of example but not limitation, the host interface 132 may include a buffer manager 52, an event queue 54 and a command queue 56. The command queue 56 may sequentially store commands, data, and the like received from the host 102 and output them to the buffer manager 52 in an order in which they are stored. The buffer manager 52 may classify, manage or adjust the commands, the data, and the like, which are received from the command queue 56. The event queue 54 may sequentially transmit events for processing the commands, the data, and the like received from the buffer manager 52.

A plurality of commands or data of the same characteristic, e.g., read or write commands, may be received from the host 102. Alternatively, a plurality of commands or data of different characteristics may be transmitted to the memory system 110 after being mixed or jumbled by the host 102. For example, the host 102 may transmit a plurality of commands for reading data (i.e., read commands). For another example, the host 102 may transmit commands for reading data (i.e., read commands) and programming/writing data (i.e., write commands). The host interface 132 may store commands, data, and the like, which are received from the host 102, to the command queue 56 sequentially. Thereafter, the host interface 132 may estimate or predict what kind of internal operation the controller 130 will perform according to the characteristics of commands, data, and the like, which have been received from the host 102. The host interface 132 may determine a processing order and a priority of commands and data, based at least on their characteristics. According to characteristics of commands and data, the buffer manager 52 of the host interface 132 is configured to determine whether the buffer manager 52 should store commands and data in the first memory 144, or whether the buffer manager 52 should deliver the commands and the data to the flash translation layer (FTL) 40. The event queue 54 receives events from the buffer manager 52, which are to be internally executed and processed by the memory system 110 or the controller 130 in response to the commands and the data, so as to deliver the events into the flash translation layer (FTL) 40 in the order received.

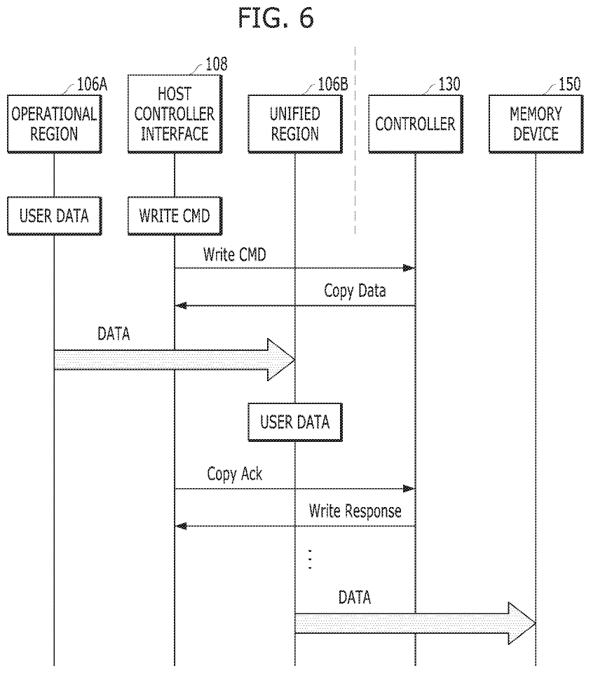

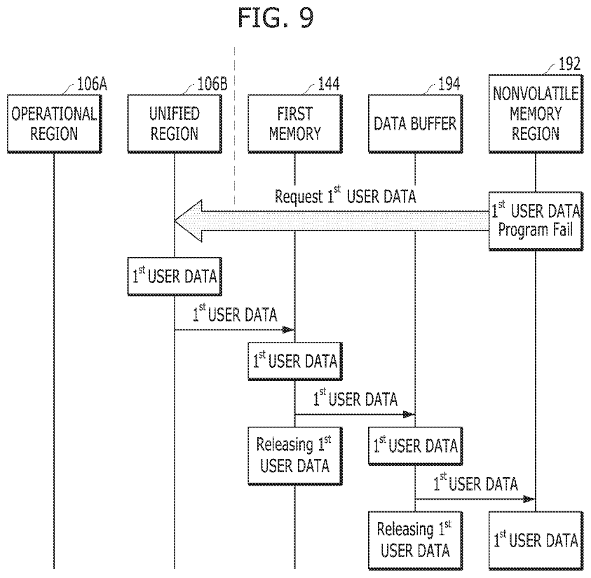

In accordance with an embodiment, the host interface 132 in FIG. 3 may perform some functions of the controller 130 in FIGS. 1 and 2. The host interface 132 may set the memory 106 in the host 102, which is shown in FIG. 6 or 9, as a slave and add the memory 106 as an additional storage space which is controllable or usable by the controller 130.

In accordance with an embodiment, the flash translation layer (FTL) 40 may include a state manager 42, a map manager (MM) 44, a host request manager (HRM) 46 and a block manager 48. The host request manager (HRM) 46 may manage the events from the event queue 54. The map manager (MM) 44 may handle or control map data. The state manager 42 may perform garbage collection (GC) or wear leveling (WL). The block manager 48 may execute commands or instructions to a block in the memory device 150.

By way of example but not limitation, the host request manager 46 may use the map manager 44 and the block manager 48 to handle or process requests according to the read and program commands, and events which are delivered from the host interface 132. The host request manager 46 may send an inquiry request to the map data manager 44, to determine a physical address corresponding to the logical address which is entered with the events. The host request manager 46 may send a read request with the physical address to the memory interface 142, to process the read request (or handle the events). On the other hand, the host request manager 46 may send a program request (or write request) to the block manager 48, to program data to a specific empty page (no data) in the memory device 150. Then, the host request manager 46 may transmit a map update request corresponding to the program request to the map manager 44, to update an item relevant to the programmed data in information of mapping the logical-to-physical addresses to each other.

The block manager 48 may convert a program request delivered from the host request manager 46, the map data manager 44, and/or the state manager 42 into a flash program request used for the memory device 150, to manage flash blocks in the memory device 150. In order to maximize or enhance program or write performance of the memory system 110 of FIG. 2), the block manager 48 may collect program requests and send flash program requests for multiple-plane and one-shot program operations to the memory interface 142. In an embodiment, the block manager 48 sends several flash program requests to the memory interface 142 to enhance or maximize parallel processing of the multi-channel and multi-directional flash controller (i.e., the memory interface 142).

The block manager 48 may be configured to manage blocks in the memory device 150 according to the number of valid pages. Further, the block manager 48 may select and erase blocks having no valid pages when a free block is needed, and select a block including the least number of valid pages when it is determined that garbage collection is necessary. The state manager 42 may perform garbage collection to move the valid data to an empty block and erase the blocks from which the valid data was moved so that the block manager 48 may have enough free blocks (i.e., empty blocks with no data). If the block manager 48 provides information regarding a block to be erased to the state manager 42, the state manager 42 could check all flash pages of the block to be erased to determine whether each page is valid. For example, to determine validity of each page, the state manager 42 may identify a logical address stored in an area (e.g., an out-of-band (OOB) area) of each page. To determine whether each page is valid, the state manager 42 may compare the physical address of the page with the physical address mapped to the logical address obtained from the inquiry request. The state manager 42 sends a program request to the block manager 48 for each valid page. A mapping table may be updated through the update of the map manager 44 when the program operation is complete.

The map manager 44 may manage a logical-to-physical mapping table. The map manager 44 may process requests such as queries, updates, and the like, which are generated by the host request manager 46 or the state manager 42. The map manager 44 may store the entire mapping table in the memory device 150 (e.g., a flash/non-volatile memory) and cache mapping entries according to the storage capacity of the first memory 144. When a map cache miss occurs while processing inquiry or update requests, the map manager 44 may send a read request to the memory interface 142 to load a relevant mapping table stored in the memory device 150. When the number of dirty cache blocks in the map manager 44 exceeds a certain threshold, a program request may be sent to the block manager 48 so that a clean cache block is made and the dirty map table may be stored in the memory device 150.

When garbage collection is performed, the state manager 42 copies valid page(s) into a free block, and the host request manager 46 may program the latest version of the data for the same logical address of the page and currently issue an update request. When the status manager 42 requests the map update in a state in which copying of valid page(s) is not completed properly, the map manager 44 might not perform the mapping table update. It is because the map request is issued with old physical information if the status manger 42 requests a map update and a valid page copy is completed later. The map manager 44 may perform a map update operation to ensure accuracy only if the latest map table still points to the old physical address.

In accordance with an embodiment, at least one of the state manager 42, the map manager 44 or the block manager 48 may include circuitry for performing its own operation. As used in the disclosure, the term ‘circuitry’ refers to any or all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” also covers an implementation of merely a processor (or multiple processors) or portion of a processor and its (or their) accompanying software and/or firmware. The term “circuitry” also covers, for example, and if applicable to a particular claim element, an integrated circuit for a storage device.

The memory device 150 may include a plurality of memory blocks. The plurality of memory blocks may be any of different types of memory blocks such as single level cell (SLC) memory blocks, multi level cell (MLC) memory blocks or the like, according to the number of bits that can be stored or represented in one memory cell. An SLC memory block includes a plurality of pages implemented by memory cells, each storing one bit of data. An SLC memory block may have high data input and output (I/O) operation performance and high durability. An MLC memory block includes a plurality of pages implemented by memory cells, each storing multi-bit data (e.g., two bits or more). An MLC memory block may have larger storage capacity for the same space compared to a SLC memory block. An MLC memory block can be highly integrated in terms of storage capacity. In an embodiment, the memory device 150 may be implemented with any of various types of MLC memory blocks such as double level cell memory blocks, a triple level cell (TLC) memory blocks, a quadruple level cell (QLC) memory blocks and a combination thereof. The double level cell memory block may include a plurality of pages implemented by memory cells, each capable of storing 2-bit data. The triple level cell (TLC) memory block may include a plurality of pages implemented by memory cells, each capable of storing 3-bit data. The quadruple level cell (QLC) memory block may include a plurality of pages implemented by memory cells, each capable of storing 4-bit data. In another embodiment, the memory device 150 may be implemented with blocks, each including a plurality of pages implemented by memory cells, each capable of storing 5-bit or more bit data.

In an embodiment of the disclosure, the memory device 150 is embodied as a nonvolatile memory such as a flash memory such as a NAND flash memory, a NOR flash memory and the like. Alternatively, the memory device 150 may be implemented by at least one of a phase change random access memory (PCRAM), a ferroelectrics random access memory (FRAM), a spin injection magnetic memory (STT-RAM), and a spin transfer torque magnetic random access memory (STT-MRAM), or the like.

FIGS. 4 to 6 illustrate examples of increasing the operating efficiency of a memory system 110. Specifically, FIGS. 4 to 6 illustrate a case where a part of a memory in a host may be used as a buffer for temporarily storing any one of metadata or user data which should be eventually stored in the memory system.

Referring to FIG. 4, the memory system 110 may include the controller 130 and the memory device 150. The memory system 110 may cooperate with the host 102.

The host 102 may include a processor 104, a second memory 106 (referred as to a host memory), and a host controller interface 108. The host 102 in FIG. 4 may have a configuration similar to that of the host 102 in FIGS. 1 to 3. The host memory 106 may include a host memory buffer. The host controller interface 108 may include a host bridge in configuration, operation, or role. Depending on an embodiment, the host controller interface 108 may include a memory controller or a memory interface for controlling the host memory 106.

The memory system 110 may use the host memory 106 in the host 102 as a buffer for storing user data 166. In FIG. 4, a case when the host memory 106 in the host 102 stores the user data 166 is described. However, it is also possible for the controller 130 to store metadata as well as the user data 166 in the host memory 106.

The host memory 106 may include an operational region 106A and a unified region 106B. The operational region 106A of the host memory 106 may be a space used by the host 102 to store data or signal in the course of performing an operation through the processor 104. The unified region 106B of the host memory 106 may be a space used to support an operation of the memory system 110, rather than that of the host 102. The host memory 106 may be used for another purpose depending on an operation time. Sizes of the operational region 106A and the unified region 106B may be dynamically determined. Because of these features, the host memory 106 may be referred to as a provisional memory or storage.

The unified region 106B may be provided by the host 102, allocating a portion of the host memory 106 for the memory system 110. The host 102 might not use the unified region 106B for an operation internally performed in the host 102 regardless of the memory system 110. In the memory system 110, a memory device 150 may include a nonvolatile memory that spends more time to read, write, or erase data than that of the host memory 106 in the host 102, which is a volatile memory. When a time spent or required to read, write or erase data in response to a request from the host 102 becomes long, a latency may occur in the memory system 110 to continuously execute plural read and write commands from the host 102. Thus, in order to improve or enhance operational efficiency of the memory system 110, the unified region 106B in the host 102 may be utilized as a temporary storage of the memory system 110.

By way of example but not limitation, when the host 102 intends to write a large amount of data to the memory system 110, it may take a long time for the memory system 110 to program the large amount of data to the memory device 150. When the host 102 tries to write or read another data to or from the memory system 110, the associated write or read operation may be delayed because of the previous operation, i.e., it takes the long time for the memory system 110 to program the large amount of data into the memory device 150. In this case, the memory system 110 may request the host 102 to copy the large amount of data to the unified region 106B of the host memory 106 without programming the large amount of data into the memory device 150. Because a time required to copy data from the operational region 106A to the unified region 106B in the host 102 is much shorter than a time required for the memory system 110 to program the data to the memory device 150, the memory system 110 may avoid delaying the write or read operation associated with other data. Thereafter, the memory system 110 may transfer the data temporarily stored in the unified region 106B of the host memory 106 to the memory device 150, while the memory system 110 does not receive a command to read, write, or delete data from the host 102. In this way, a user might not experience slowed operation and instead may experience that the host 102 and the memory system 110 are handling or processing the user's requests at a high speed.

The controller 130 of the memory system 110 may use an allocated portion of the host memory 106 (e.g., the unified region 106B) in the host 102. The host 102 might not involve an operation performed by the memory system 110. The host 102 may transmit an instruction such as a read, a write, or a delete with a logical address into the memory system 110. The controller 130 may translate the logical address into a physical address. The controller 130 may store metadata in the unified region 106B of the host memory 106 in the host 102 when storage capacity of the first memory 144 in the controller 130 is too small to load the metadata used for translating a logical address into a physical address. In an embodiment, using the metadata stored in the unified region 106B of the host memory 106, the controller 130 may perform address translation (e.g., recognize a physical address corresponding to a logical address received from the host 102).

For example, the operation speed of the host memory 106 and the communication speed between the host 102 and the controller 130 may be faster than the speed at which the controller 130 accesses the memory device 150 and reads data stored in the memory device 150. Thus, rather than loading metadata stored from the memory device 150 as needed, the controller 130 may quickly load the metadata from the host memory 106, as needed.

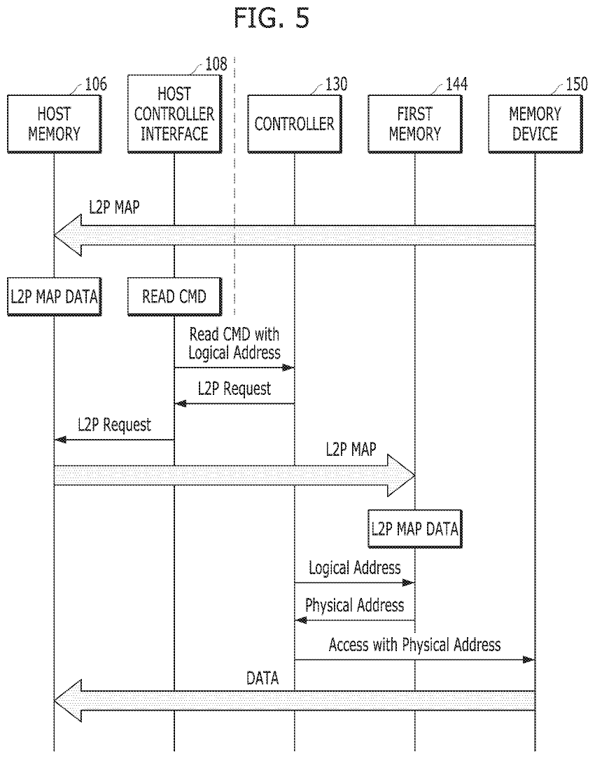

Referring to FIGS. 4 and 5, a read operation requested by the host 102 is described when metadata (i.e., logical-to-physical (L2P) MAP in FIG. 5) is stored in the host memory 106 of the host 102. After power is supplied into the host 102 and the memory system 110, the host 102 and the memory system 110 may be engaged with each other. When the host 102 and the memory system 110 cooperate, the metadata (L2P MAP) stored in the memory device 150 may be transferred into the host memory 106. Storage capacity of the host memory 106 may be larger than that of the first memory 144 used by the controller 130 in the memory system 110. Therefore, even if some or all of the metadata (L2P MAP) stored in the memory device 150 is entirely or mostly transferred into the host memory 106, it might not be burden operations of the host 102 and the memory system 110. The metadata (L2P MAP) transmitted into the host memory 106 may be stored in the unified region 106B in FIG. 4.

When a read command (READ CMD) is issued by the processor 104 in the host 102, the read command may be transmitted to the host controller interface 108. The host controller interface 108 may receive a read command and then transmit the read command with a logical address to the controller 130 of the memory system 110.

When the first memory 144 does not include metadata relevant to the logical address entered from the host 102, the controller 130 in the memory system 110 may request from the host controller interface 108 the metadata corresponding to the logical address (L2P Request). The host controller interface 108 may transmit a corresponding portion of the metadata (L2P MAP) stored in the host memory 106 to the memory system 110 in response to the request of the controller 130.

As storage capacity of the memory device 150 increases, a range of logical addresses may widen or increase. For example, the value of the logical address (e.g., LBN1 to LBN2*10⁹) may correspond to the storage capacity of the memory device 150. The host memory 106 may store metadata corresponding to most or all of the logical addresses, but the first memory 144 in the memory system 110 might not have sufficient space to store the metadata. When the controller 130 may determine that a logical address from the host 102 with the read command may belong to a particular range (e.g., LBN120 to LBN600), the controller 130 may request the host controller interface 108 to send one or more metadata corresponding to the particular range (e.g., LBN120 to LBN600) or a larger range (e.g., LBN100 to LBN800). The host controller interface 108 may transmit the metadata requested by the controller 130 to the memory system 110. The transmitted metadata (L2P MAP) may be stored in the first memory 144 of the memory system 110.

The controller 130 may translate a logical address received from the host 102 into a physical address based on the metadata (L2P MAP) stored in the first memory 144. The controller 130 may use the physical address to access the memory device 150. Data requested by the host 102 may be transferred from the memory device 150 to the host memory 106. The data transferred from the memory device 150 in response to the read command (READ CMD) may be stored in the operational region 106A of the host memory 106.

As described above, the host memory 106 is used as a buffer for storing metadata (L2P MAP) so that the controller 130 might not instantly read or store the metadata (L2P MAP) from the memory device 150. Accordingly, operational efficiency of the memory system 110 may be improved or enhanced.

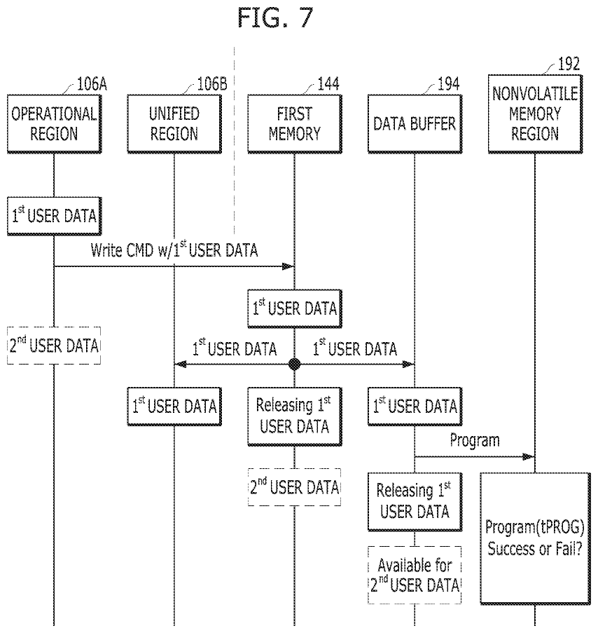

Referring to FIGS. 4 and 5, an example in which the memory system 110 uses the host memory 106 in the host 102 as a data buffer in response to a write command of the host 102 will be described. In FIG. 6, the host memory 106 in the host 102 may include an operational region 106A and a unified region 106B, which configuration is also shown in FIGS. 7 and 9.

Referring to FIG. 6, when a write command (WRITE CMD) is issued by the processor 104 in the host 102, the write command is passed to the host controller interface 108. The write command may be accompanied by data (USER DATA). An amount of data to be transferred with the write command may have a size corresponding to one page or less, a size corresponding to a plurality of pages, a plurality of blocks or more. In the example of FIG. 6, the data accompanying the write command has a very large volume or size.

The host controller interface 108 notifies the controller 130 in the memory system 110 of the write command (Write CMD). At this time, the controller 130 may request the host controller interface 108 to copy data corresponding to the write command (Copy Data) to the unified region 106B. That is, the controller 130 may use the unified region 106B as a write buffer, instead of receiving the data along with the write command and storing the data in the memory device 150.

According to a request entered from the controller 130, the host controller interface 108 may copy the data corresponding to the write command (Write CMD) stored in the operational region 106A to the unified region 106B. Thereafter, the host controller interface 108 may notify the controller 130 that the copy operation is completed (Copy Ack) in response to the request delivered from the controller 130. After recognizing that the data corresponding to the write command (Write CMD) has been copied by the host controller interface 108 from the operational region 106A to the unified region 106B, the controller 130 may inform completion of a write operation corresponding to the write command (Write CMD) to the host controller interface 108 (Write Response).

When the operation for a write command (Write CMD) involving a large volume of data (e.g., voluminous data) is completed through the above-described process, the memory system 110 may be ready to perform another operation corresponding to the next command entered from the host 102.

On the other hand, the data corresponding to a write command (Write CMD) temporarily stored in the unified region 106B may be transferred and stored into the memory device 150 by the memory system 110 when there is no command entered from the host 102.

FIG. 7 illustrates a first operation of a host and a memory system according to an embodiment of the disclosure. Regarding a write operation, FIG. 7 shows detailed operations performed between the memory system 110 and the host 102, specifically, between the memory system 110 and the host memory 106 described with reference to FIGS. 1 to 4.

Referring to FIG. 7, the write operation may occur in order to program or write data generated by the host 102 in the memory system 110. According to user's request, the host 102 may perform an operation, and as a result, first user data (1^{st}: USER DATA) that is required to be stored may be generated. The host 102 may store the first user data (1^{st} USER DATA) in the operation region 106A.

The host 102 may transmit the first user data (1^{st} USER DATA) stored in the operational region 106A to the memory system 110 along with a write command (Write CMD). The memory system 110 may receive the first user data (1^{st} USER DATA) and store the first user data (1^{st} USER DATA) in the first memory 144 of the controller 130.

The controller 130 transmits the first user data (1^{st} USER DATA) stored in the first memory 144 to both the host 102 and the data buffer 194 after starting to perform a write operation in response to the write command (Write CMD). The host 102 may receive the first user data (1^{st} USER DATA) and store the first user data (1^{st} USER DATA) in the unified region 106B which is allocated for the memory system 110.

The first memory 144 may work as a cache in the controller 130 and might not hold the first user data (1^{st} USER DATA) a long time for increasing or enhancing performance of the memory system 110. The first memory 144 may release the first user data (1^{st} USER DATA) after the first user data (1^{st} USER DATA) is transferred to the data buffer 194 and the host 102.

When the first user data (1^{st} USER DATA) stored in the data buffer 194 is programmed into the nonvolatile memory region 192, the data buffer 194 may release the first user data (1^{st} USER DATA). In the nonvolatile memory region 192, it may take a certain time to program the first user data (1^{st} USER DATA) and to verify a success or a failure of program.

While the first user data (1^{st} USER DATA) is programmed in the nonvolatile memory region 192, the first memory 144 and the data buffer 194 are used for storing second user data (2^{nd} USER DATA) which may be next data received from the host 102 after the first user data (1^{st} USER DATA) is delivered. As a time that the first memory 144 and the data buffer 194 hold the first user data (1^{st} USER DATA) decreases, their operational margins capable of handling or processing other data such as the second user data (2^{nd} USER DATA) may be secured. This may improve operational efficiency of the memory system 110. Accordingly, even if the data buffer 194 does not have larger storage capability, input/output (I/O) performance of the memory system 100 may be improved or enhanced.

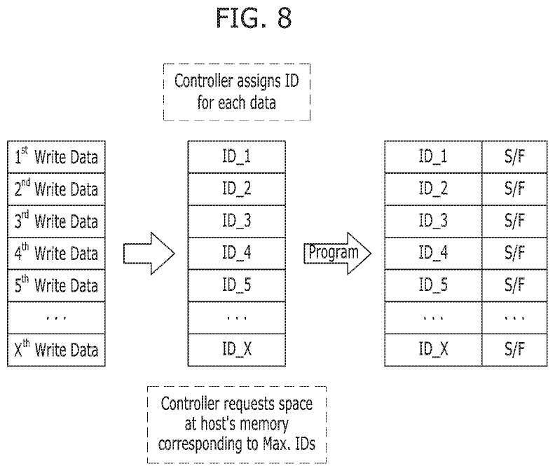

FIG. 8 illustrates an operation of a controller according to an embodiment of the disclosure.

Referring to FIG. 8, the controller 130 may assign an identifier (ID) to each piece of data, any or all of which may be a large amount of data or voluminous data and multiple pieces may be continuously or sequentially inputted from the host 102. For example, it is assumed that X pieces of write data (1^{st} Write Data to Xth Write Data) may be inputted with a write command from the host 102 (X is a positive integer greater than 1). The controller 130 may assign identifiers ID_1 to ID_X to respective pieces of write data (1^{st} Write Data to Xth Write Data).

In an embodiment, X pieces may be the maximum number of pieces of write data that the controller 130 can process or handle at a time. In another embodiment, the maximum number of pieces of write data may be set by a protocol or a specification between the memory system 110 and the host 102 (see FIGS. 1 to 4). The controller 130 may make a request to the host 102 to secure a storage space for storing X pieces of write data. In response to the request of the controller 130, the host 102 may allocate at least some of the unified region 106B in FIGS. 4 to 7 for the storage space requested by the controller 130.

According to an embodiment, the host 102 may allocate a set area for the memory system 110 so that the controller 130 can directly access and utilize the set area even without an inquiry or a request sent from the memory system 110 or the controller 130 and a response or acknowledgement sent from the host 102.

The controller 130 may assign an identifier to a piece of write data and then start to program the piece of write data in the nonvolatile memory region 192. After verifying whether the piece of data is completely programmed in the nonvolatile memory region 192 of the memory device 150, a success or a failure (S/F) signal indicating whether or not the piece of write data was successfully programmed may be delivered into the controller 130. Based on this signal, the controller 130 can determine the particular piece of data for which programming failed based on the ID.

The controller 130 may assign an identifier before transferring the piece of write data stored in the first memory 144 to the data buffer 194 and the host 102. The piece of write data with an identifier may be delivered to the data buffer 194 and the host 102.

In a memory system including a data buffer configured to hold a piece of write data for a re-program operation, which occurs when a program operation fails, while the piece of write data is programmed, an identifier may be not necessary. This is because it is possible for the data buffer 194 to identify and specify which piece of the write data is currently programmed through an undergoing operation. In an embodiment of the disclosure, the first memory 144 and the data buffer 194 do not hold or store a piece of write data until it is verified whether the piece of write data is completely programmed so that an identifier (ID) may be required to request the piece of write data which is not completely programmed. That is, even though a piece of write data is not completely programmed in the nonvolatile memory region 192, all interfaces or components in the memory device 150, the controller 130 and the host 102 may specify and recognize the piece of write data through an identifier ID.

FIG. 9 illustrates a second operation performed between a host and a memory system according to an embodiment of the disclosure. The second operation is described in the context that the first user data (1^{st} USER DATA) is not completely programmed in the nonvolatile memory region 192.

Referring to FIG. 9, when the first user data (1^{st} USER DATA) is not completely programmed in the nonvolatile memory region 192, the controller 130 may request the host 102 to transmit the first user data (1^{st} USER DATA). In this case, the controller 130 may use the identifier ID to identify the first user data (1^{st} USER DATA).

The host 102 may find the first user data (1^{st} USER DATA) stored in the unified region 106B and transmit the first user data (1^{st} USER DATA) to the memory system 110. The controller 130 may receive the first user data (1^{st} USER DATA), from the host 102 and store the first user data in the first memory 144.

The first user data (1^{st} USER DATA) stored in the memory 144 is transferred to the data buffer 194. Then, the first memory 144 may release the first user data (1^{st} USER DATA).

The data buffer 194 may transfer the first user data (1^{st} USER DATA) received from the first memory 144 to the nonvolatile memory region 192 for re-programming. When the first user data (1^{st} USER DATA) is transferred to the nonvolatile memory region 192, the data buffer 194 may release the first user data (1^{st} USER DATA).

In FIG. 9, the first user data (1^{st} USER DATA) may represent any piece of write data, e.g., a large amount of write data or voluminous data continuously or subsequently inputted from the host 102. In response to a program failure, the controller 130 may perform a reprogram operation according to one of various policies or methods. By way of example but not limitation, after recognizing a program failure regarding at least one piece of write data, the controller 130 may perform the reprogram operation prior to another operation requested by the host 102 (e.g., operations corresponding to other commands inputted from the host 102).

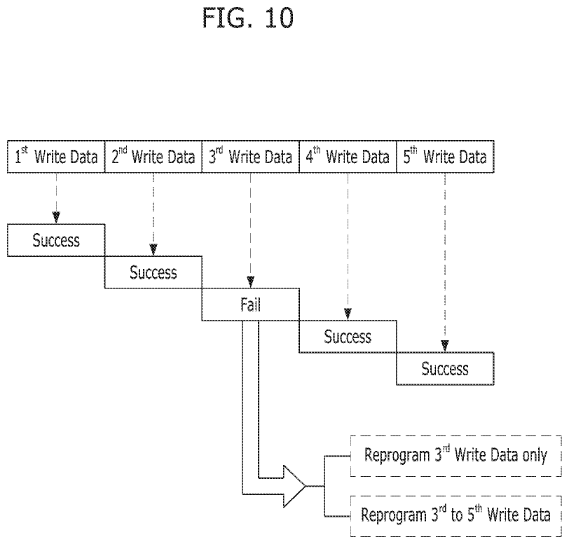

FIG. 10 illustrates a reprogram operation according to an embodiment of the disclosure.

Referring to FIG. 10, when a program failure occurs regarding some of plural pieces of write data, the controller 130 may determine a range or extent of a reprogram operation. The controller 130 may use the identifier ID in a process of determining the range of the reprogram operation. In an embodiment, when each piece of write data can be distinguished based on assigned identifier ID, the controller 130 may dynamically determine the range of the reprogram operation based on an operational environment.

By way of example but not limitation, while five pieces of write data (1^{st} Write Data to 5th Write Data) are attempted to be sequentially programmed into the nonvolatile memory region 192, the third piece of write data (3^{rd} Write Data) is not completely programmed, that is, the programming failed for the third piece of data. The controller 130 may recognize the program failure of the third piece of write data (3^{rd} Write Data). In this case, the controller 130 may reprogram only the third piece of write data (3^{rd} Write Data) among the five pieces of write data (1^{st} Write Data to 5^{th} Write Data).

According to an embodiment, in order to secure data safety, the controller 130 may determine a more extensive reprogram operation, that is, reprogramming the third write data (3^{rd} Write Data) to the last write data, i.e., fifth Write Data (5^{th} Write Data), which represents the range of the program operation in this example.

On the other hand, a program failure may occur intermittently in a process of programming many dozen pieces of write data. In this case, the controller 130 may reprogram a piece of write data which corresponds to a program failure among the many dozen pieces of write data. According to another embodiment, the controller 130 may determine the range of reprogram operation to be from the earliest write data for which programming failed to the last write data.

FIG. 11 illustrates a third operation performed in a memory system according to an embodiment of the disclosure.

Referring to FIG. 11, the third operation may include operations S12, S14 and S16. The operation S12 may include receiving a piece of write data inputted with a write command from a host and storing the piece of write data in a cache. The operation S14 may include delivering the piece of write data to a data buffer and a host memory when a write operation corresponding to the write command is performed or begun. The operation S16 may include programming the piece of write data delivered to the data buffer to a nonvolatile memory region.

A method for operating the memory system may further include requesting the host to use a storage region of a host memory which corresponds to a size of write data that the controller 130 can process or handle at a time, or receiving a notice regarding the storage region within the host memory, which is allocated by the host in response to a request sent by a controller of the memory system.

The data buffer according to an embodiment of the disclosure may release a piece of write data before receiving a verification result for the piece of write data which is programmed to a nonvolatile memory block. In addition, the cache in the controller 130 may release the piece of write data after transferring the piece of write data to the data buffer and the host. The cache and the data buffer may deliver the piece of data to another component and then release the data, so that a storage space for temporarily storing a next piece of write data in the cache and the data buffer may be secured earlier. In this way, a delay or a bottleneck that may occur in the cache and the data buffer may be avoided. Accordingly, input/output (I/O) performance of the memory system may be improved or enhanced.

On the other hand, the data buffer does not hold the piece of write data until a program operation is verified, so that there is a risk that the piece of write data may be lost in case of program failure. To avoid this risk, the piece of write data may be backed up in a host memory by transferring and storing the same piece of write data in the host memory when the piece of write data is transferred to the data buffer in response to execution of the write command.

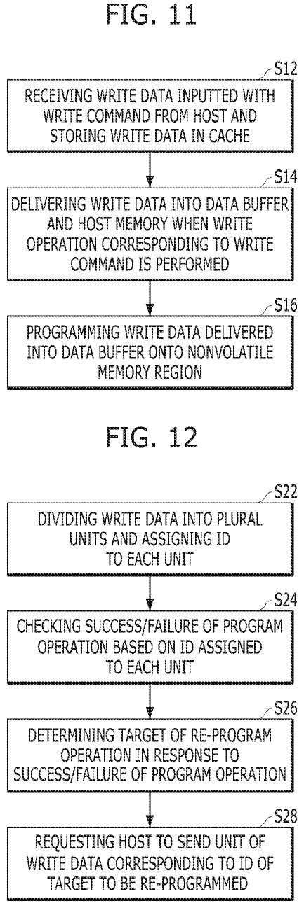

FIG. 12 illustrates a fourth operation performed in a memory system according to an embodiment of the disclosure.

Referring to FIG. 12, the fourth operation may include operations S22, S24, S26, S28. The operation S22 may include dividing write data, inputted from a host, into plural units (e.g., plural pieces of write data, each of which may be the same size) and assigning an identifier (ID) to each unit. By the way of example but not limitation, each unit can be one or more pieces of write data, which is considered a group of write data which are delivered from the data buffer 194 and programmed in the nonvolatile memory region 192 together. The operation S24 may include checking success or failure of a program operation regarding each unit based on the corresponding identifier (ID). The operation S26 may include determining a target (or a range) of a re-program operation in response to the success or the failure of the program operations. The operation S28 may include requesting a host to send one or more units of write data corresponding to the identifier(s) of the target (or the range) to be re-programmed (S28).

Referring to FIGS. 8 and 12, the memory system may assign an identifier (ID) in response to each unit of write data being received from the host. When a unit of write data is not completely programmed in a nonvolatile memory region within the memory system, the memory system may recognize such failure by the corresponding identifier.

In response to the success or the failure of program operation, the memory system may determine a reprogram target or a reprogram range (S26). Referring to FIGS. 10 and 12, the reprogram target or the reprogram range may be determined differently depending on various factors. According to an embodiment, the reprogram target or the reprogram range may be dynamically determined corresponding to an operational environment of the memory system. By the way of example but not limitation, the reprogram target or the reprogram range may be geared down when the memory system or the memory device is overloaded. When the memory system or the memory device is underloaded, the reprogram target or the reprogram range may be extended. In addition, according to an embodiment, the memory system may determine the reprogram target or the reprogram range in response to a set policy.

After determining the reprogram target or the reprogram range, the memory system may request the host to send one or more units of write data stored in the host memory (S28). As described with reference to FIG. 11, an interface such as a bridge in the host may store a unit of write data, received from the memory system in response to execution of a write operation, in a host memory, and retransmit a present unit of write data corresponding to a request or an inquiry sent from the memory system.

The host may control a storage space allocated for the memory system, before the memory system transmits a preset unit of write data in response to the execution of the write operation. For example, when a memory system completes a write operation regarding a large amount of write data or plural preset units of write data, the memory system may notify the host memory or the host bridge of completing the write operation through a response. When the host memory or the host bridge receives the response, the host memory or the host bridge may release old data, e.g., all preset units of write data which are previously transmitted when the write operation is performed.

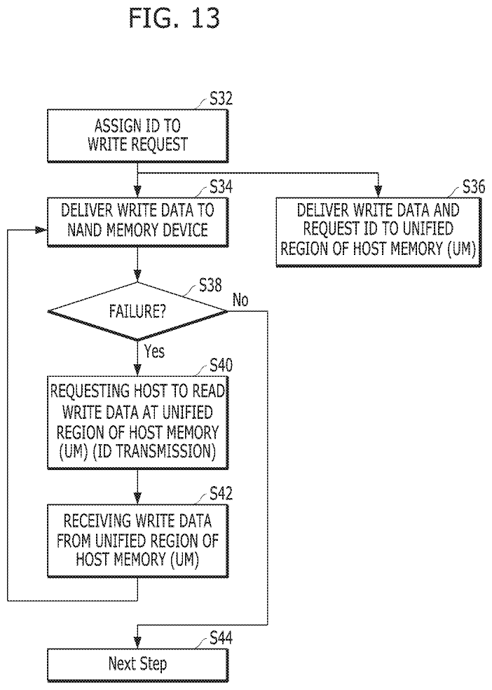

FIG. 13 illustrates a fifth operation performed in a memory system according to an embodiment of the disclosure.

Referring to FIG. 13, the fifth operation may include operations S32 to S44. The operation S32 may include assigning an identifier (ID) to a write request. The operation S34 may include delivering a piece of write data corresponding to the write request to a nonvolatile memory region (e.g., NAND memory device). The operation S36 may include delivering the piece of write data and the identifier to a unified region of host memory (UM) in a host. The write request may be considered a write command. After the identifier is assigned to the write request, the memory system may perform the operations of delivering the piece of write data to the nonvolatile memory region (S34) and the step of delivering the piece of write data to the unified region of the host (S36). The operations S34, S36 may be performed serially or in parallel. The steps of delivering the piece of write data to the unified region of the host and to the nonvolatile memory region may be performed at the same time or at different times.

The memory system may verify whether the programming of the piece of write data in the nonvolatile memory region has failed (S38). When the programming did not fail (No in S38), a next operation or another operation requested to or arranged by the memory system may be performed (S44).

When the programming in the nonvolatile memory region failed (Yes in S38), the memory system may request the host to read the piece of write data stored at the unified region of the host memory (UM) (S40). In this case, the memory system may transmit the identifier (ID), which is assigned to the piece of write data in response to the write request, to the host (i.e., ID transmission). The host may access the piece of write data in the unified region and transmit the piece of write data to the memory system.

In response to the identifier ID, when the host (or the host memory) transmits the piece of write data stored in the unified region, the memory system may receive the piece of write data again (S42). Thereafter, the memory system may transfer the received piece of write data to the nonvolatile memory region (e.g., NAND memory device) to reprogram the piece of write data (S34).

According to embodiments of the disclosure, a data processing system and a method of operating the data processing system may avoid delay in data transmission, which occurs due to a program operation verification in a process of programming a large amount of data in the data processing system to a nonvolatile memory block, thereby improving data input/output (I/O) performance of the data processing system or a memory system thereof.

In addition, according to an embodiment of the disclosure, the memory system may selectively perform a re-program operation based on a result of the program operation verification by utilizing a memory included in a host or a computing device as a backup memory device for a program operation performed in the memory system, thereby increasing or improving operational efficiency of the memory system.

Further, in an embodiment of the disclosure, a data processing system including a memory system and a host or a computing device may estimate an operational state (e.g., health, lifespan, or etc.) of a nonvolatile memory block based on the number of data transfers that occurred due to a re-program operation. In this case, information about safety of data programmed to the nonvolatile memory block, which can be determined based on the operational state, may be provided to the user.

While the present teachings have been illustrated and described with respect to specific embodiments, it will be apparent to those skilled in the art in light of the present disclosure that various changes and modifications may be made without departing from the spirit and scope of the disclosure as defined in the following claims.

What is claimed is:

1. A memory system comprising:
a memory device including a nonvolatile memory region and a data buffer configured to temporarily store a piece of data stored in the nonvolatile memory region; and
a controller configured to store write data, which is delivered with a program command from a host including a second memory, in a first memory, and to send the write data to both the data buffer and the host when a program operation corresponding to the program command is performed.

2. The memory system according to claim 1, wherein the data buffer is configured to release the write data before it is verified whether or not the write data has been successfully programmed to the nonvolatile memory region.

3. The memory system according to claim 1, wherein the first memory is configured to release the write data after sending the write data to the data buffer.

4. The memory system according to claim 1, wherein the controller is configured to obtain the write data from the second memory, when programming the write data to the nonvolatile memory region failed.

5. The memory system according to claim 1, wherein the controller is configured to divide the write data into plural pieces of write data, each piece having a set size, assign an identifier to each of the plural pieces of write data, and send the plural pieces of write data and their respective identifiers to both the data buffer and the second memory.

6. The memory system according to claim 5, wherein the memory device is configured to send a signal indicating a program success/failure to the controller in response to the identifier assigned to each of the plural pieces of write data.

7. The memory system according to claim 6, wherein the controller is configured to determine that only a piece of write data matched with its identifier corresponding to the program failure is reprogrammed.

8. The memory system according to claim 6, wherein the controller is configured to determine that plural pieces of write data matched with a first identifier to a last identifier, at least one of which corresponds to the program failure, are reprogrammed.

9. The memory system according to claim 5, wherein the controller is configured to access the second memory to obtain a piece of write data to be programmed again.

10. The memory system according to claim 5, wherein the controller is configured to request the host to allocate a storage area of the first memory for an operation of the memory system, wherein the storage area is configured to store a maximum number of the plural pieces of write data matched with their identifiers.

11. A method for operating a memory system, the method comprising:
receiving a piece of write data with a write command from a host and storing the piece of write data in a cache;
sending the piece of write data to a data buffer and a host memory when a write operation corresponding to the write command is performed or has begun; and
programming the piece of write data sent to the data buffer to a nonvolatile memory region.

12. The method according to claim 11, wherein the write data in the data buffer is released before it is verified whether or not the write data has been successfully programmed to the nonvolatile memory region.

13. The method according to claim 11, wherein the write data in the cache is released after sending the write data to the data buffer.

14. The method according to claim 11, further comprising:
obtaining the write data from the host memory, when programming the write data to the nonvolatile memory region failed.

15. The method according to claim 11, wherein the write data is divided into plural pieces of write data, each piece having a set size, an identifier is assigned to each of the plural pieces of write data, and the plural pieces of write data and their respective identifiers are transferred to both the data buffer and the host memory.

16. The method according to claim 11, further comprising:
determining a program success/failure in response to the identifier assigned to each of the plural pieces of write data.

17. The method according to claim 16, further comprising:
determining that only a piece of write data matched with its identifier corresponding to the program failure is reprogrammed.

18. The method according to claim 16, further comprising:
determining that plural pieces of write data matched with a first identifier to a last identifier, at least one of which corresponds to the program failure, are reprogrammed.

19. The method according to claim 16, further comprising:
accessing the host memory to obtain a piece of write data to be programmed again.

20. The method according to claim 16, further comprising:
requesting the host to allocate a storage area of the first memory for an operation of the memory system, wherein the storage area is capable of storing a maximum number of the plural pieces of write data matched with their respective identifiers.
